(19) United States
(12) Patent Application Publication
(10) Pub. No.: US 2025/0212143 A1
(43) Pub. Date: Jun. 26, 2025

(54) SYNCHRONOUS COMMUNICATION DEVICE, PROCESSING METHOD OF SYNCHRONOUS COMMUNICATION DEVICE, AND STORAGE MEDIUM

(71) Applicant: CANON KABUSHIKI KAISHA, Tokyo (JP)

(72) Inventor: MOTOHARU SUZUKI, Kanagawa (JP)

(21) Appl. No.: 18/984,660

(22) Filed: Dec. 17, 2024

(30) Foreign Application Priority Data
Dec. 22, 2023 (JP) 2023-216832

(51) Int. Cl. H04W 56/00; H04W 52/02

(52) U.S. Cl. CPC H04W 56/0015; H04W 52/0277; H04W 56/005

(57) ABSTRACT

A synchronous communication device includes a first determination unit configured to determine whether its own synchronous communication device is to be a synchronization source or a synchronization destination when there is a request for time synchronization between the own synchronous communication device and another synchronous communication device that are connected to a wireless network, and a second determination unit configured to determine whether a wireless mode of the own synchronous communication device is to be a master mode or a slave mode in accordance with the determination by the first determination unit.

### BACKGROUND

### Field

The present disclosure relates to a synchronous communication device, a processing method of a synchronous communication device, and a storage medium.

### Description of the Related Art

In recent years, electronic devices such as digital cameras, printers, mobile phones, and smartphones have been equipped with wireless communication functions. Due to the spread of wireless functions, there are an increasing number of use cases in which time synchronization is achieved using a network not only between wired communication devices but also between wireless communication devices.

Japanese Patent Application Laid-Open No. 2022-21695 discusses a technique for synchronous control between communication devices by which switching between synchronous control using a wired network and synchronous control using a wireless network is performed. Japanese Patent Application Laid-Open No. 2022-21695 discusses a method for achieving synchronization even in a place where it is difficult to establish synchronization in wireless communication, by synchronous control using a wired network in a wireless communication section with much radio interference.

Japanese Patent Application Laid-Open No. 2018-88644 discusses a technique for achieving highly accurate time synchronization between a plurality of wireless devices. Specifically, the time synchronization source terminal is set as an access point (hereinafter, AP) in wireless communication, and the time synchronization destination terminal is set as a station (hereinafter, STA) that is wirelessly connected to the synchronization source terminal.

For obtaining highly accurate time synchronization, the following issues need to be solved. The technique discussed in Japanese Patent Application Laid-Open No. 2022-21695 is effective in the case where wired time synchronization can be used in combination with wireless time synchronization, but is not applicable to the case where only wireless time synchronization is available between network devices.

In order to perform time synchronization processing between wireless devices, it is first necessary to build a wireless network. In addition, in order to perform a highly accurate time synchronization process, it is necessary to stably transmit time-sensitive packets, that is, packets with time constraints on packet transmission, among various packets used for time synchronization.

On the other hand, in a wireless local area network (LAN), an infrastructure network is generally constituted of one wireless AP and one or more slave devices (hereinafter, STA). In this network, the communication timings of various packets of all AP/STAs are controlled by the AP. Therefore, the device that is the time synchronization source and needs to transmit the above time-sensitive packet desirably operates in an AP mode.

In Japanese Patent Application Laid-Open No. 2018-88644, a user who runs an application that uses time synchronization in a wireless environment needs to make wireless settings and source/destination settings for time synchronization in consideration of the above-described matter.

### SUMMARY

The present disclosure is directed to enabling easy time synchronization of synchronous communication devices connected to a wireless network.

According to an aspect of the present disclosure, a synchronous communication device includes a first determination unit configured to determine whether its own synchronous communication device is to be a synchronization source or a synchronization destination when there is a request for time synchronization between the own synchronous communication device and another synchronous communication device that are connected to a wireless network, and a second determination unit configured to determine whether a wireless mode of the own synchronous communication device is to be a master mode or a slave mode in accordance with the determination by the first determination unit.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of a synchronous communication device.

FIG. 2 is a diagram illustrating an example of a functional configuration of the synchronous communication device.

FIGS. 3A to 3C illustrate an example of a network configuration.

FIG. 4 is a flowchart illustrating a processing method of synchronous communication devices.

FIG. 5 is a flowchart illustrating checking of the number of devices participating in a synchronous wireless network.

FIG. 6 is a flowchart illustrating determination of a synchronization source terminal.

FIG. 7 is a flowchart illustrating reconstruction of a synchronous wireless network.

FIG. 8 is a sequence diagram illustrating a time synchronization process.

FIG. 9 is a flowchart illustrating a synchronization process in an access point (AP) mode.

FIG. 10 is a flowchart illustrating a synchronization process in a station (STA) mode.

### DESCRIPTION OF THE EMBODIMENTS

A synchronous communication device according to a first exemplary embodiment will be described. In the present exemplary embodiment, the synchronous communication device is applied to a digital camera as an example. However, the synchronous communication device does not necessarily have to be a digital camera. For example, the synchronous communication device may be another device such as a mobile phone, a personal computer (PC), a video camera, a smart watch, or a personal digital assistant (PDA).

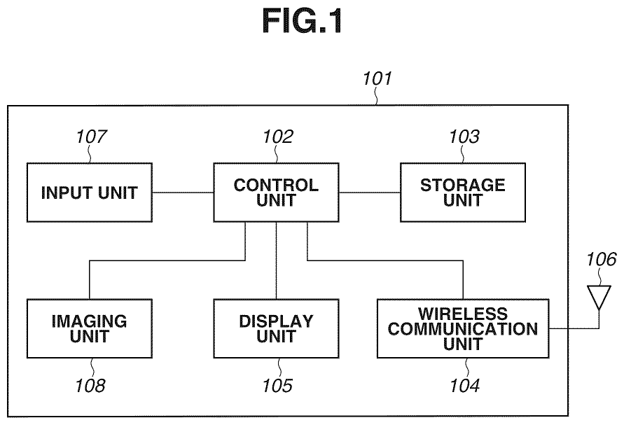

FIG. 1 is a block diagram illustrating an example of a hardware configuration of a synchronous communication device 101 according to the first exemplary embodiment. The synchronous communication device 101 includes a control unit 102, a storage unit 103, a wireless communication unit 104, a display unit 105, an input unit 107, and an imaging unit 108.

The control unit 102 is a control unit that controls the entire synchronous communication device 101 by executing control programs stored in the storage unit 103. Operations of the synchronous communication device 101 described below are implemented by the control unit 102 executing the control programs stored in the storage unit 103. The control unit 102 is constituted of a central processing unit (CPU), for example.

The storage unit 103 stores the control programs executed by the control unit 102, imaging data generated by the imaging unit 108, and communication packets used for wireless communication with other devices.

The wireless communication unit 104 is a wireless communication unit for performing wireless communication in a wireless local area network (LAN) or the like conforming to the IEEE 802.11 series. In the present exemplary embodiment, the wireless communication unit 104 is compatible with IEEE 802.11v used in performing a time synchronization process.

The display unit 105 provides various displays, and has a function of outputting visually perceptible information, like a liquid crystal device (LCD) or a light emitting diode (LED).

The antenna 106 is an antenna unit connected to the wireless communication unit 104. The antenna 106 transmits and receives wireless packets required for wireless communication with other devices.

The input unit 107 is an input unit through which the user inputs various types of information, and has an operation function for the user to operate the synchronous communication device 101.

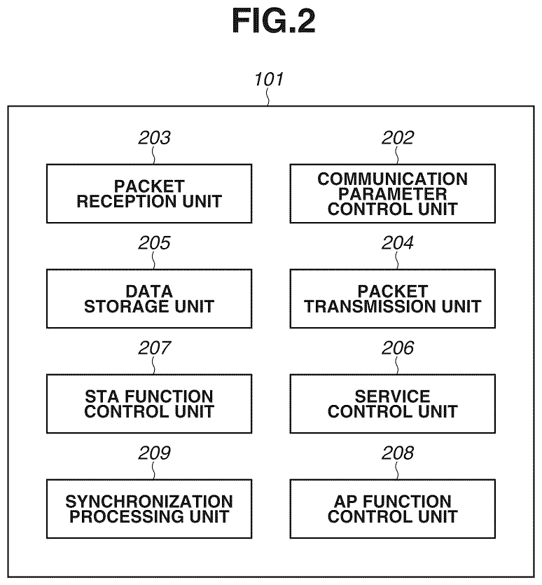

The imaging unit 108 captures images. The imaging unit 108 is capable of capturing images at the shutter timing coinciding with those of other devices, based on time information of synchronization with the other devices by a synchronization processing unit 209 illustrated in FIG. 2 described below. Above is the description of FIG. 1.

FIG. 2 is a block diagram illustrating an example of a functional configuration of the synchronous communication device 101 illustrated in FIG. 1. The synchronous communication device 101 has a communication parameter control unit 202, a packet reception unit 203, a packet transmission unit 204, a data storage unit 205, a service control unit 206, an STA function control unit 207, an AP function control unit 208, and a synchronization processing unit 209. The control unit 102 illustrated in FIG. 1 executes programs stored in the storage unit 103 to implement the functional configuration units illustrated in FIG. 2.

The communication parameter control unit 202 executes a communication parameter sharing process for sharing communication parameters between terminals. The communication parameter control unit 202 provides communication parameters for an AP to cause an STA to wirelessly connect to a wireless network established by the AP. The AP is an example of a master device, and the STA is an example of a slave device.

The communication parameters include wireless communication parameters necessary for wireless LAN communication, such as a service set identifier (SSID) as a network identifier, an encryption method, an encryption key, an authentication method, and an authentication key. The communication parameters may also include a connector, a media access control (MAC) address, a pre-shared key (PSK), a passphrase, an internet protocol (IP) address for communication in the IP layer, information necessary for higher-level services, and network usage, and the like, as specified in the Wi-Fi device provisioning protocol (DPP).

The communication parameter sharing process is executed based on the DPP by the communication parameter control unit 202. However, the communication parameter sharing process executed by the communication parameter control unit 202 may be another process based on Wi-Fi Protected Setup (WPS) or Wi-Fi Direct. When DPP is used, the communication parameters provided by the configurator are encrypted with a private key dedicated to the configurator. A wireless network can be formed using the communication parameter control unit 202 for purposes other than time synchronization (for example, transfer of imaging data).

The packet reception unit 203 and the packet transmission unit 204 control the transmission and reception of all packets including higher-layer communication protocols. The packet reception unit 203 and the packet transmission unit 204 also control the wireless communication unit 104 to transmit and receive packets conforming to the IEEE802.11 standard to and from the opposite terminal.

The data storage unit 205 controls writing and reading of programs, communication parameters, authentication information, and the like to and from the storage unit 103.

The service control unit 206 is a service control unit in the application layer. The application layer here refers to a service provision layer among the fifth to higher layers in the OSI reference model. That is, the service control unit 206 executes transfer of imaging data and the like, using wireless communication by the wireless communication unit 104.

The STA function control unit 207 provides a function with which to operate as an STA in the infrastructure mode defined in the IEEE 802.11 standard. When operating as an STA, the STA function control unit 207 performs authentication and encryption processing and the like.

The AP function control unit 208 provides a function with which to operate as an AP in the infrastructure mode defined in the IEEE 802.11 standard. The AP function control unit 208 forms a wireless network and performs authentication and encryption processing for STAs, management of STAs, and the like. The AP function control unit 208 also has a function to count the number of STAs connected to the wireless network.

The synchronization processing unit 209 uses the wireless network connected by the communication parameter control unit 202 to perform processing for time synchronization between the AP and the STAs.

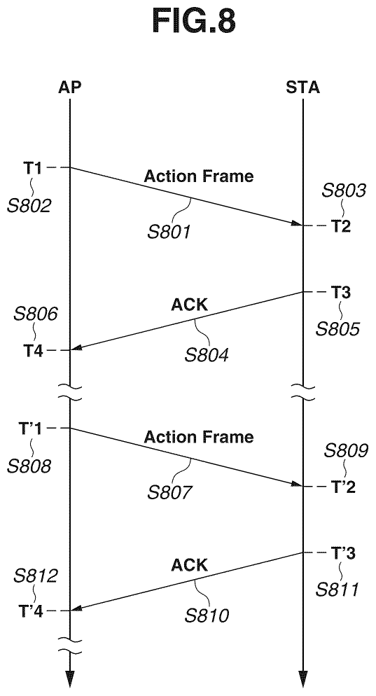

In the present exemplary embodiment, the synchronous communication device 101 has a function with which to operate in the synchronization source mode and the synchronization destination mode. The sequence and processing flows of time synchronization will be described with reference to FIGS. 8, 9, and 10. Above is the description of FIG. 2.

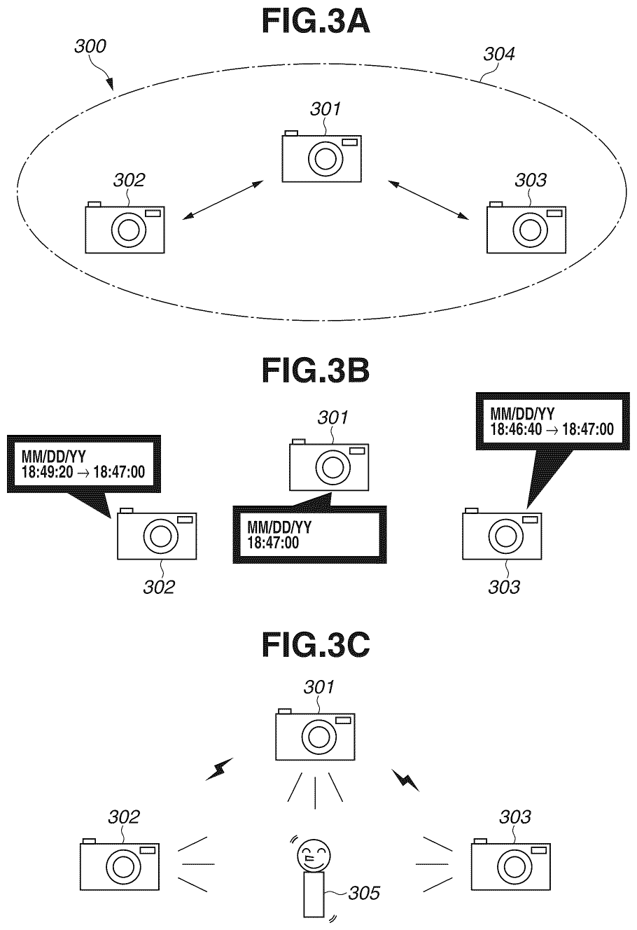

Next, a communication system 300 to which the synchronous communication device 101 is applicable and its use cases will be described with reference to FIGS. 3A to 3C.

FIGS. 3A to 3C are diagrams illustrating an example of a configuration of the communication system 300 according to the present exemplary embodiment. The communication system 300 has digital cameras 301, 302, and 303. The digital cameras 301, 302, and 303 are examples of the synchronous communication device 101 illustrated in FIGS. 1 and 2, and have the components illustrated in FIGS. 1 and 2.

The digital cameras 301, 302, and 303 are connected to a wireless network 304 in the infrastructure mode defined in the IEEE 802.11 standard. The digital camera 301 currently constructs the wireless network 304 as an AP. The digital cameras 302 and 303 participate in the wireless network 304 as STAs. The number of digital cameras is three here, but it may be two or four or more.

FIG. 3B is a diagram for describing the time synchronization function of the digital cameras 301, 302, and 303. Referring to FIG. 3B, the times of the digital cameras 302 and 303 are synchronized with the time of the digital camera 301. Accordingly, even when the image data captured by the plurality of digital cameras 301 to 303 is brought together, it possible to group/sort the image data by time stamp.

FIG. 3C is a diagram for describing an application using the time synchronization function of the digital cameras 301 to 303. FIG. 3C illustrates a system in which the digital cameras 302 and 303 are released in accordance with the release timing of the digital camera 301. Although all the digital cameras 301 to 303 are directed toward a subject 305, the subject does not necessarily have to be the same.

There are cases where highly accurate synchronization processing is required. For example, in the case of generating a 3D model from images captured by the plurality of digital cameras 301 to 303, if the subject 305 is a moving object, the 3D model will be made clearer by using images captured with as high synchronization accuracy as possible. Above is the description of an example of the communication system 300 to which the synchronous communication device 101 is applicable and its use cases.

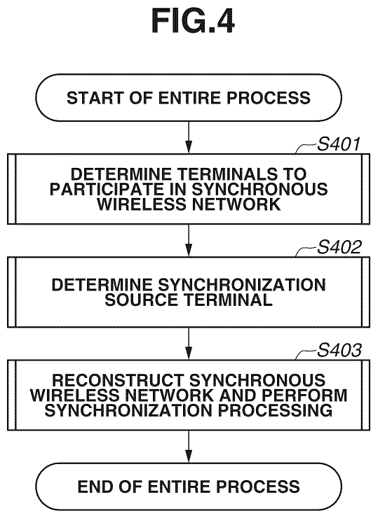

FIG. 4 is a flowchart illustrating a processing method of the synchronous communication device 101 according to the present exemplary embodiment. The process in FIG. 4 is implemented by the control unit 102 executing a program stored in the storage unit 103. The process in FIG. 4 is roughly divided into three steps S401 to S403.

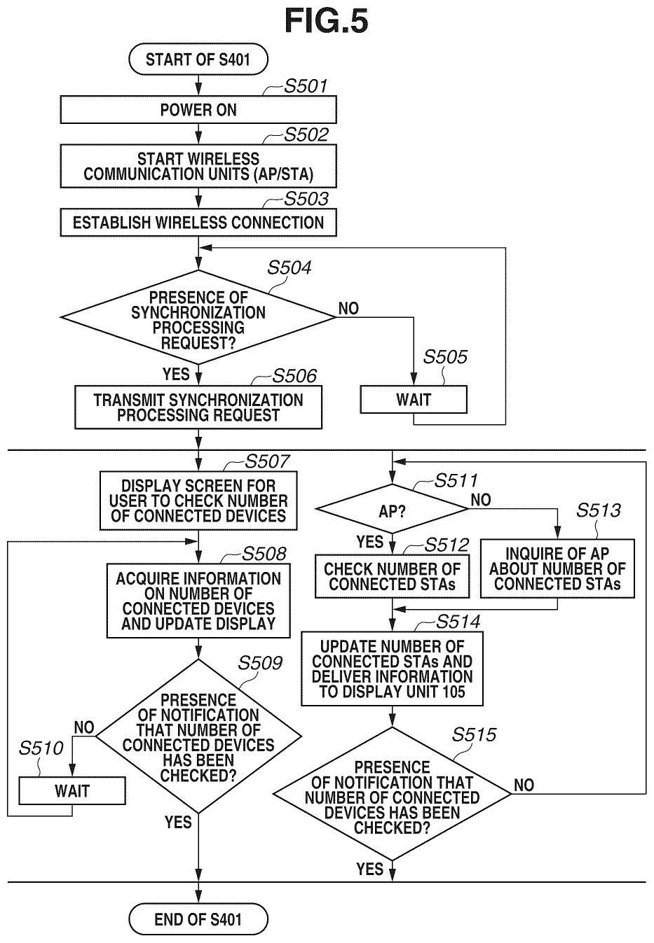

In step S401, the synchronous communication device 101 determines terminals to participate in a wireless network constituted of a terminal group performing synchronization processing (hereinafter, synchronous wireless network). The details of this step will be described below with reference to FIG. 5.

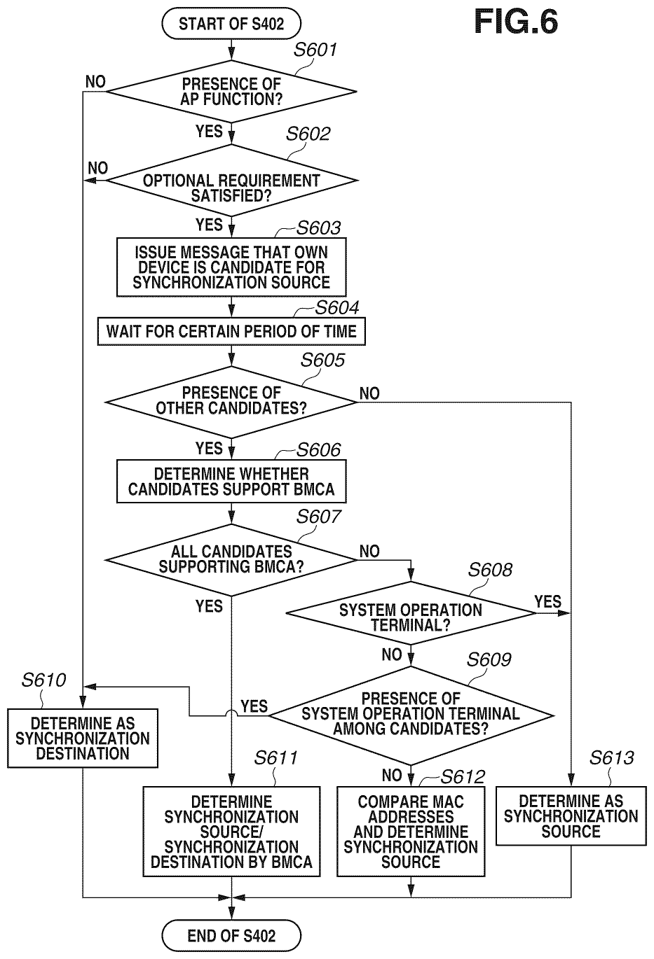

In step S402, the synchronous communication device 101 determines which terminal among the terminals that have participated in the synchronous wireless network is to be set as the synchronization source. The details of this step will be described below with reference to FIG. 6.

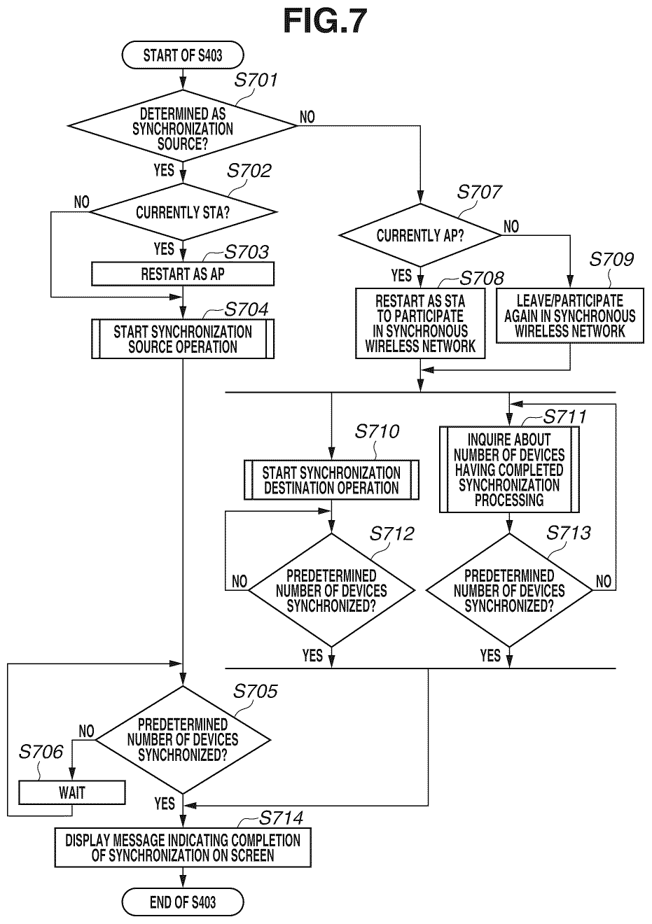

In step S403, the synchronous communication device 101 reconstructs the synchronous wireless network in accordance with the determined matter, and performs a time synchronization process. The details of this step will be described below with reference to FIG. 7. This concludes description of the overall operation flow of the synchronous communication device 101.

FIG. 5 is a flowchart illustrating the details of step S401 in FIG. 4. First, in step S501, the control unit 102 powers on the synchronous communication device 101.

In step S502, the control unit 102 starts the wireless communication unit 104 of the synchronous communication device 101. The wireless communication unit 104 may be started automatically by the control unit 102, or may be started in response to a user's operation on the input unit 107. At this point in time, the wireless mode of the wireless communication unit 104 may be either the AP mode or the STA mode. The AP mode is an example of the master mode, and the STA mode is an example of the slave mode.

In step S503, the control unit 102 makes a wireless connection by the wireless communication unit 104. If the wireless communication unit 104 is started up in the AP mode, the control unit 102 performs a process of allowing another synchronous communication device 101 to participate in the synchronous wireless network, in response to a connection request from the other synchronous communication device 101. If the synchronous communication device 101 is started up as an STA, the control unit 102 performs a process of participating in the desired synchronous wireless network.

In step S504, the control unit 102 determines whether a synchronization processing request to its own synchronous communication device 101 is present. A synchronization processing request occurs in two cases. In the first case, a synchronization processing request is made by a user operating the own synchronous communication device 101 via the input unit 107. In the second case, a synchronization processing request is received from another synchronous communication device 101 participating in the synchronous wireless network. If a synchronization processing request is not present (NO in step S504), the process proceeds to step S505. If a synchronization processing request is present (YES in step S504), the process proceeds to step S506.

In step S505, the control unit 102 waits until a synchronization processing request occurs, and then the process returns to step S504.

In step S506, if the synchronization processing request has been made by a user operation, the control unit 102 transmits the synchronization processing request via the wireless communication unit 104 to the other synchronous communication devices 101 participating in the synchronous wireless network.

In step S507, if the control unit 102 has received the synchronization processing request, the control unit 102 controls the display unit 105 to display a screen for the user to check the number of connected devices. The screen may display the number of terminals currently participating in the synchronous wireless network, information on the other synchronous communication devices 101, specifically, the MAC addresses, names, host names, and the like of the other synchronous communication devices 101.

In step S508, the control unit 102 performs a control to update the information on the other connected synchronous communication devices 101 and update the above display on the screen. The acquisition of the details of display will be described below in steps S512 and S513.

In step S509, the control unit 102 determines whether a notification has been received that all synchronous communication devices 101 among which time synchronization is desired are connected. The notification may be received from the user operating the own synchronous communication device 101 via the input unit 107, or may be received from another synchronous communication device 101 belonging to the synchronous wireless network. If the notification has not been received (NO in step S509), the process proceeds to step S510. If the notification has been received (YES in step S509), the processing in step S401 is ended.

In step S510, the control unit 102 waits until the notification is received. Then, the process returns to step S508. In step S508, the control unit 102 repeats the above processing. The control unit 102 performs a process of updating the above display on the screen until the notification is received.

In step S511, the control unit 102 determines whether the communication mode of the wireless communication unit 104 is the AP mode. If the communication mode is the AP mode (YES in step S511), the process proceeds to step S512. If the communication mode is the STA mode (NO in step S511), the process proceeds to step S513.

In step S512, the control unit 102 checks the number of synchronous communication devices 101 connected in the STA mode to the synchronous wireless network. Then, the process proceeds to step S514.

In step S513, the control unit 102 inquires of the AP via the wireless communication unit 104 about the number of synchronous communication devices 101 connected in the STA mode to the synchronous wireless network, and receives the information on the number of synchronous communication devices 101 connected in the STA mode to the synchronous wireless network.

Then, the process proceeds to step S514.

In step S514, the control unit 102 updates the number of synchronous communication devices 101 connected in the STA mode to the synchronous wireless network, and controls the display unit 105 to display the number of synchronous communication devices 101 connected in the STA mode to the synchronous wireless network. The control unit 102 functions here as a display control unit.

In step S515, the control unit 102 determines whether a notification has been received that all synchronous communication devices 101 among which time synchronization is desired are connected. If the notification has not been received (NO in step S515), the process returns to step S511. If the notification has been received (YES in step S515), the processing in step S401 is ended. Above is the description of FIG. 5.

FIG. 6 is a flowchart illustrating the details of step S402 in FIG. 4. First, in step S601, the control unit 102 determines whether its own synchronous communication device 101 has the AP function. If the synchronous communication device 101 has the AP function (YES in step S601), the process proceeds to step S602.

If the synchronous communication device 101 has no AP function (NO in step S601), the process proceeds to step S610.

In step S602, the control unit 102 determines whether an optional requirement is satisfied.

The optional requirement may be set arbitrarily based on the properties of the synchronous communication device 101, the application used, and the like. For example, the optional requirement may include a function related to time such as whether the synchronous communication device 101 is connected to another network and the time is distributed from the other network to the synchronous communication device 101. Furthermore, the optional requirement may be a requirement unrelated to the time function, such as, in a case where the synchronous communication device 101 operates on battery, whether the remaining battery power is at least a predetermined level. This makes it possible to prevent the synchronization source from becoming unable to perform its function due to unintentional battery exhaustion. If the optional requirement is satisfied (YES in step S602), the process proceeds to step S603. If the optional requirement is not satisfied (NO in step S602), the process proceeds to step S610.

In step S603, the control unit 102 determines that the own synchronous communication device 101 is a synchronous communication device 101 that can operate as the synchronization source, and notifies the other synchronous communication devices 101 via the wireless communication unit 104 that the own synchronous communication device 101 is a candidate for the synchronization source.

In step S604, the control unit 102 waits for a certain period of time until all of the synchronous communication devices 101 in the synchronous wireless network have completed the above determination and transmitted the determination results.

In step S605, the control unit 102 determines whether there are other candidate synchronous communication devices 101 that can be the synchronization source in the synchronous wireless network. If there are no synchronous communication devices 101 that are candidates for the synchronization source other than the own synchronous communication device 101 (NO in step S605), the process proceeds to step S613. If there are synchronous communication devices 101 that are candidates for the synchronization source other than the own synchronous communication device 101 (YES in step S605), the process proceeds to step S606. In step S606, the control unit 102 selects which one to operate as the synchronization source.

In step S606, the control unit 102 determines whether the synchronous communication devices 101 that are candidates for the synchronization source, support Best Master Clock Algorithm (BMCA) defined in IEEE 1588. Although its detailed description is omitted, BMCA is an algorithm for selecting a synchronization source (also expressed as grand master (GM)) from a device group in a network.

In step S607, the control unit 102 determines whether all of the synchronous communication devices 101 that are candidates for the synchronization source support BMCA defined in IEEE 1588. If all of the candidates support BMCA (YES in step S607), the process proceeds to step S611. If any of the candidates do not support BMCA (NO in step S607), the process proceeds to step S608.

In step S608, in order to select the synchronization source by another method, the control unit 102 determines whether the own synchronous communication device 101 is a system operation terminal. That is, the control unit 102 determines whether the own synchronous communication device 101 is a synchronous communication device 101 operated by the user via a graphical user interface (GUI). If the own synchronous communication device 101 is a synchronous communication device 101 operated by the user via the GUI (YES in step S608), the control unit 102 determines that the own synchronous communication device 101 is a system operation terminal. Since the system operation terminal is the synchronization source, the process proceeds to step S613. If the own synchronous communication device 101 is not a synchronous communication device 101 operated by the user via the GUI (NO in step S608), the control unit 102 determines that the own synchronous communication device 101 is not a system operation terminal, and the process proceeds to step S609.

In step S609, the control unit 102 determines whether there is a system operation terminal among the synchronous communication devices 101 that are candidates for the synchronization source. If there is a system operation terminal (YES in step S609), the system operation terminal is the synchronization source, and the process proceeds to step S610. If there is no system operation terminal (NO in step S609), the process proceeds to step S612.

In step S610, the control unit 102 determines that the own synchronous communication device 101 is to immediately become a synchronization destination, and the processing in step S402 is ended.

In step S611, in order to select one synchronization source, the control unit 102 determines whether each synchronous communication device 101 in the synchronous wireless network is to be the synchronization source or a synchronization destination by BMCA. The BMCA processing is performed by transmitting and receiving a packet called an announce packet. Under BMCA, a synchronous communication device 101 that satisfies the function of a time synchronization source transmits the announce packet. The control unit 102 compares information included in the announce packet of the own synchronous communication device 101 with that of the other synchronous communication devices 101. If the own synchronous communication device 101 is to be the synchronization source with a higher priority, the control unit 102 continues transmission of the announce packet. If the control unit 102 determines that another synchronous communication device 101 has a higher priority, the control unit 102 stops the transmission of the announce packet. Accordingly, the synchronous communication device 101 that has continued to transmit the announce packet to the end is determined as the synchronization source. Therefore, the synchronous communication device 101 on which the result of the determination in step S607 was YES starts to transmit the announce packet, whereby the BMCA processing is started without any problem. Then, the processing in step S402 is ended.

In step S612, the control unit 102 compares the MAC addresses of the synchronous communication devices 101 that are candidates for the synchronization source in the synchronous wireless network, and determines that the synchronous communication device 101 with the smallest MAC address value is to be the synchronization source. The control unit 102 then determines the remaining synchronous communication devices 101 to be the synchronization destinations. Since it is sufficient to ultimately determine one synchronization source, the control unit 102 may determine one synchronization source by a method other than the above-described method. Thereafter, the processing in step S402 is ended.

In step S613, the control unit 102 determines that the own synchronous communication device 101 is to be the synchronization source, and the processing in step S402 is ended.

There may be a case where there are no synchronous communication devices 101 that are candidates for the synchronization source in the synchronous wireless network (the results of the determination on all of the synchronous communication devices 101 are NO in S602). In that case, measures may be taken such as arranging a synchronous communication device 101 that satisfies the optional requirement, or changing the optional requirement and making a synchronization request again. For example, if the optional requirement includes the remaining battery amount, the battery may be charged and then the determination may be retried. Above is the description of FIG. 6.

As described above, referring to FIG. 6, the control unit 102 functions as a determination unit. Upon receipt of a request for time synchronization between the own synchronous communication device 101 and other synchronous communication devices 101 that are connected to a wireless network, the control unit 102 determines whether the own synchronous communication device 101 is to be the synchronization source or a synchronization destination.

In a case where the own synchronous communication device 101 and other synchronous communication devices 101 are candidates for the synchronization source, the control unit 102 determines whether the own synchronous communication device 101 is to be the synchronization source or a synchronization destination so that there is only one synchronization source.

In step S602, the control unit 102 determines whether the own synchronous communication device 101 is to be the synchronization source or a synchronization destination based on the information of the own synchronous communication device 101. For example, the control unit 102 determines whether the own synchronous communication device 101 is to be the synchronization source or a synchronization destination based on the remaining battery amount of the own synchronous communication device 101.

In step S611, the control unit 102 determines, by BMCA, whether the own synchronous communication device 101 is to be the synchronization source or a synchronization destination.

In step S612, the control unit 102 determines whether the own synchronous communication device 101 is to be the synchronization source or a synchronization destination, based on the MAC addresses of the own synchronous communication device 101 and the other synchronous communication devices 101.

FIG. 7 is a flowchart illustrating the details of step S403 in FIG. 4. First, in step S701, the control unit 102 determines whether the own synchronous communication device 101 has been determined as the synchronization source. If the own synchronous communication device 101 has been determined as the synchronization source (YES in step S701), the process proceeds to step S702. If the own synchronous communication device 101 has been determined as a synchronization destination (NO in step S701), the process proceeds to step S707.

In step S702, the control unit 102 determines whether the current wireless mode of the wireless communication unit 104 is the STA mode. If the wireless mode is the STA mode (YES in step S702), the process proceeds to step S703. If the wireless mode is the AP mode (NO in step S702), the process proceeds to step S704.

In step S703, the control unit 102 causes the wireless communication unit 104 to leave the network once, and restarts the wireless communication unit 104 in the AP mode. Then, the process proceeds to step S704.

In step S704, the control unit 102 starts an operation of performing synchronization processing as the synchronization source. The details of step S704 will be described with reference to FIGS. 8 to 10.

In step S705, the control unit 102 operates as the synchronization source, monitors the synchronized states of the other synchronous communication devices 101 performing synchronization processing as synchronization destinations, and determines whether all of the synchronous communication devices 101 are completely synchronized. As a monitoring method, if the synchronization source uses a synchronization method by which the synchronized states of the synchronization destinations are known, the synchronization source continues monitoring of the synchronized states by using the method.

If the synchronization source uses a monitoring method by which the synchronized states of the synchronization destinations are unknown, the synchronization source needs to separately inquire the synchronized states of the synchronization destinations periodically. If there is any synchronous communication device 101 that has not completed synchronization (NO in step S705), the process proceeds to step S706. If all of the synchronous communication devices 101 have completed synchronization (YES in step S705), the process proceeds to step S714.

In step S706, the control unit 102 waits until all of the synchronous communication devices 101 complete synchronization, and then the process returns to step S705.

In step S707, the control unit 102 determines whether the current wireless mode of the wireless communication unit 104 is the AP mode. If the wireless mode is the AP mode (YES in step S707), the process proceeds to step S708. If the wireless mode is the STA mode (NO in step S707), the process proceeds to step S709.

In step S708, the control unit 102 restarts the wireless communication unit 104 in the STA mode. Then, the control unit 102 searches for a synchronous wireless network in which the own synchronous communication device 101 is to participate, using the wireless communication unit 104. If any is found, the own synchronous communication device 101 participates in the found synchronous wireless network.

In step S709, the control unit 102 does not change the wireless mode, but if the AP of the synchronous wireless network is changed, the wireless communication unit 104 leaves the synchronous wireless network once and then participates again in the synchronous wireless network established by the new AP.

Thereafter, in step S710, the control unit 102 starts an operation of performing synchronization processing as a synchronization destination. That is, the control unit 102 starts a process of synchronizing with the time notified by the synchronous communication device 101 that is the synchronization source, and the process proceeds to step S712. The details of step S710 will be described in detail with reference to FIGS. 8 to 10.

In step S712, the control unit 102 operates as the synchronization source, monitors the synchronized states of the other synchronous communication devices 101 that perform synchronization processing as synchronization destinations, and determines whether all of the synchronous communication devices 101 have completed synchronization. If there is any synchronous communication device 101 that has not yet completed synchronization (NO in step S712), the process returns to step S712. If all of the synchronous communication devices 101 have completed synchronization (YES in step S712), the process proceeds to step S714.

In step S711, the control unit 102 inquires of the synchronous communication device 101 that is the synchronization source via the wireless communication unit 104 about the number of synchronous communication devices 101 that have completed synchronization processing, and receives the inquiry result. The process proceeds to step S713.

In step S713, the control unit 102 determines whether all of the synchronous communication devices 101 have completed synchronization. If there is any synchronous communication device 101 that has not yet completed synchronization (NO in step S713), the process returns to step S711. If all of the synchronous communication devices 101 have completed synchronization (YES in step S713), the process proceeds to step S714.

In step S714, the control unit 102 controls the display unit 105 to display on the screen a message indicating that synchronization has completed, and the processing in step S403 is ended.

As described above, in steps S703 and S708, the control unit 102 determines whether the wireless mode of the own synchronous communication device 101 is to be the AP mode or the STA mode, depending on the determination of the synchronization source or synchronization destination in FIG. 6.

In step S703, if the control unit 102 determines that the own synchronous communication device 101 is to be the synchronization source, the control unit 102 determines that the wireless mode of the own synchronous communication device 101 is to be the AP mode. Specifically, if the control unit 102 determines that the own synchronous communication device 101 is to be the synchronization source and the wireless mode of the own synchronous communication device 101 is the STA mode, the control unit 102 changes the wireless mode of the own synchronous communication device 101 to the AP mode.

In step S708, if the control unit 102 determines that the own synchronous communication device 101 is to be a synchronization destination, the control unit 102 determines that the wireless mode of the own synchronous communication device 101 is to be the STA mode. Specifically, if the control unit 102 determines that the own synchronous communication device 101 is to be a synchronization destination and the wireless mode of the own synchronous communication device 101 is the AP mode, the control unit 102 changes the wireless mode of the own synchronous communication device 101 to the STA mode.

Next, an example of a sequence of the time synchronization process in the present exemplary embodiment will be described.

In the present exemplary embodiment, an example of using the Timing Measurement Protocol (hereinafter, referred to as TM protocol) defined in 802.11v as the time synchronization protocol will be described with reference to FIG. 8. The procedure of the TM protocol will be described below.

First, in step S801, an AP transmits an action frame to an STA at time T1. The AP here is the synchronous communication device 101 in the AP mode, and the STA here is the synchronous communication device 101 in the STA mode. The action frame is defined in the 802.11 series.

In step S802, when the AP transmits the action frame, the AP stores the time T1 of the transmission.

In step S803, the STA receives the action frame transmitted in step S801, and stores time T2 of the reception.

In step S804, the STA transmits an ACK frame to the AP at time T3.

In step S805, the STA, like the AP, stores the time T3 of transmission of the ACK frame.

In step S806, the AP receives the ACK frame transmitted in step S804 and stores time T4 of the reception.

In step S807, the AP transmits an action frame to the STA. This action frame includes information on the times T1 and T4.

In step S808, like in step S802, when the AP transmits the action frame, the AP stores time T′1 of the transmission.

In step S809, the STA receives the action frame, and stores time T′2 of the reception, like in step S803.

In step S810, the STA transmits an ACK to the AP.

In step S811, the STA stores time T′3 of transmission of the ACK, like in step S805.

In step S812, the AP receives the ACK frame transmitted in step S810 and stores time T′4 of the reception.

Although not illustrated in FIG. 8, when the AP transmits an action frame the next time, times T′1 and T′4 are included in the action frame. Repeating this processing periodically allows the STA to acquire the times T1 to T4 (or T′1 to T′4). Assuming that delay time Td between the STA and the AP is symmetrical in both directions, the delay time Td can be calculated by the following equation (1):

$$Td = ( ( T 4 - T 1 ) - ( T 3 - T 2 ) ) / 2 \qquad ( 1 )$$

Time difference To between the STA and the AP is calculated by the following equation (2):

$$To = T 2 - ( T1 + Td ) \qquad ( 2 )$$

The STA can achieve time synchronization with the AP by adding To the own system time. Under the TM protocol, the times T1 to T4 are 32 bits, with one bit defined as 10 nanoseconds. Therefore, there are not enough information bits to achieve synchronization using the system time (for example, a time expression that counts the number of seconds elapsed since 00:00:00 on Jan. 1, 1970, such as POSIX time). Accordingly, in transmitting an action frame, the system time is synchronized by adding the system time (for example, 64 bits, with one bit defined as 10 nanoseconds) to a vendor specific ID field.

There are two methods for synchronizing the system time. In the first method (hereinafter, referred to as pattern A), not only the 32-bit times but also the system times are stored in steps S802, S803, S805, and S806, and the system times (the system time at T1 and the system time at T4) are also transmitted in step S807. The STA can achieve synchronization of the system time in the same manner by replacing the times T1 to T4 in the equations (1) and (2) with the respective system times. As a matter of course, in order to comply with the TM protocol, the STA may be implemented to transmit also the 32-bit times at the same time in step S807. The system times are acquired not only in steps S802, S803, S805, and S806, but also in step S808 and thereafter.

In the second method (hereinafter, referred to as pattern B), the time T1 and the corresponding system time (Ts1) are stored in step S802, and the times T1, T4, and Ts1 are transmitted in step S807. The STA calculates the delay times Td and To by the equations (1) and (2), and then calculates new system time Tnew using the equation (3) below. The STA can achieve time synchronization with the AP by applying the system time Tnew obtained by the following equation (3):

$$Tnew = Ts 1 + To \qquad ( 3 )$$

The STA applies the system time Tnew to correct the time of the own synchronous communication device 101 so as to be synchronized with the time of the synchronization source AP.

In parallel with the time synchronization, the STA may adjust the own (STA's) clock frequency to match the clock frequency of the AP. The following is the equation (4) for calculation:

$$Fratio = ( {T}^{′} 1 - T 1 ) / ( {T}^{′} 2 - T 2 ) \qquad ( 4 )$$

If the solution of the equation (4) is less than 1, which indicates that the clock frequency of the STA is higher than the clock frequency of the AP, the STA adjusts its clock frequency to be slower. Similarly, if the solution of the equation (4) is greater than 1, the STA adjusts its clock frequency to be faster.

Under the TM protocol, normally, before transmission of the action frame in step S801, it is confirmed whether the synchronous communication devices 101 support the TM protocol. In the present exemplary embodiment, the AP and STA are implemented on the premise that they support the TM protocol, so the confirmation process is omitted. However, the confirmation process may be performed before the sequence in FIG. 8 is started.

The protocol for time synchronization is not limited to the TM protocol, and may be Network Time Protocol (NTP) or Precision Time Protocol (PTP), for example. Even if a protocol other than the TM protocol is used for time synchronization, the STA is supposed to bring itself into synchronization with the time of the AP.

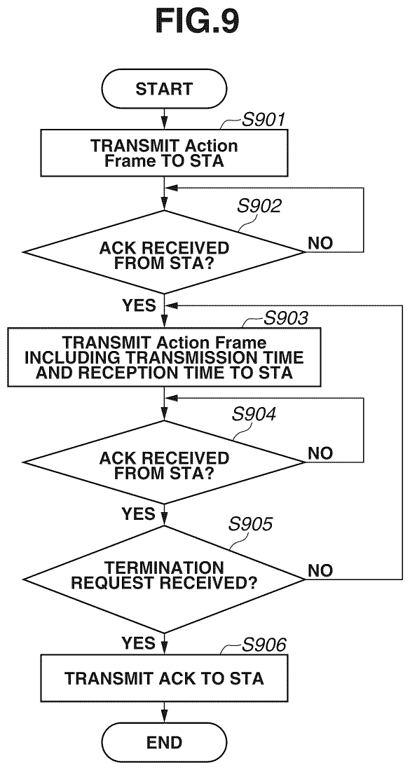

FIG. 9 is a flowchart illustrating operations of the AP in the time synchronization sequence of FIG. 8.

First, in step S901, the AP transmits an action frame for time synchronization to the STA and stores the transmission time. The AP stores not only the 32-bit transmission time but also the system time (64 bits).

In step S902, the AP waits for an ACK from the STA that has received the action frame. Upon receipt of an ACK (YES in step S902), the AP stores the reception time. If the above-described pattern A is used, the AP also stores the system time in this step.

In step S903, the AP transmits an action frame including the transmission time of the action frame and the reception time of the ACK to the STA, and stores the transmission time of the action frame. The AP stores the transmission time (32-bit time and system time), as in step S901.

In step S904, the AP waits for an ACK from the STA that has received the action frame. Upon receipt of an ACK (YES in step S904), the AP stores the reception time.

As in step S902, if the above-described pattern A is used, the AP also stores the system time in this step.

In step S905, the AP determines whether a termination request has been received from the STA. If a termination request has not been received (NO in step S905), the process returns to step S903. If a termination request has been received (YES in step S905), the process proceeds to step S906.

The receipt of a termination request in step S905 may be determined based on a trigger field of a TM request frame (see 802.11v for details) set to “0”. The termination request may be a network disconnection request from the STA (for example, a deauthentication frame or a disassociation frame), or may be determined as a termination request based on another frame.

In step S906, the AP transmits an ACK to the STA in response to the termination request, and the process of the flowchart in FIG. 9 is ended.

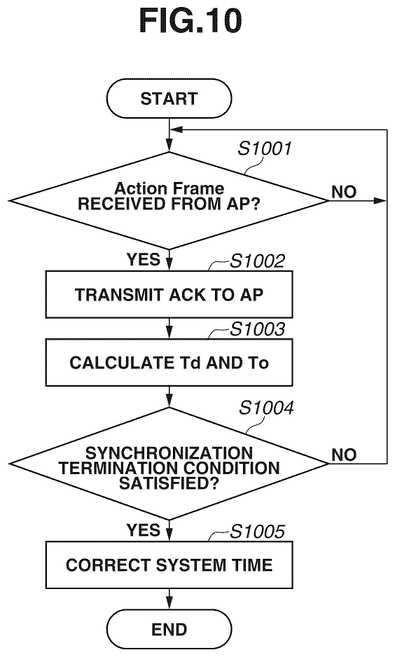

FIG. 10 is a flowchart illustrating operations of the STA in the time synchronization sequence of FIG. 8. First, in step S1001, the STA waits for an action frame from the AP. Upon receipt of an action frame (YES in step S1001), the STA stores the reception time.

In step S1002, the STA transmits an ACK to the AP indicating that the STA has received the action frame, and stores the transmission time. In the case of using the pattern A, the STA also stores the system times at the transmission time and reception time.

In step S1003, the STA calculates Td and To using the reception time of the action frame and transmission time of the ACK stored by the STA itself, and the transmission time of the action frame and the reception time of the ACK in the action frame received in step S1001. The delay time Td is calculated by the equation (1). The time difference To is calculated by the equation (2).

These calculations cannot be performed highly accurately because the firstly received action frame does not include a valid transmission time and reception time. Therefore, the STA may skip step S1003 only for the first action frame.

In step S1004, the STA determines whether a termination condition for time synchronization is satisfied. If the termination condition is not satisfied (NO in step S1004), the process returns to step S1001. If the termination condition is satisfied (YES in step S1004), the process proceeds to step S1005.

In step S1005, the STA corrects the own (STA's) system time using the delay time Td and the time difference To, and the process of the flowchart in FIG. 10 is ended.

The termination condition may be the number of calculations of Td and To, the confirmation of convergence of the delay time Td by statistical processing of the calculation results, or the like, for example. In addition, the values used for correction in step S1005 may be average values or statistical values of the calculation results.

According to the above description, the AP and the STA can achieve time synchronization. The above is an example of a time synchronization processing method using IEEE802.11v.

According to the present exemplary embodiment, a user who wishes to run a synchronous application that requires time synchronization among a plurality of synchronous communication devices 101 connected wirelessly can build a wireless network that can achieve high-accuracy time synchronization without any special knowledge.

A second exemplary embodiment will be described. In the first exemplary embodiment, in step S401 of FIG. 4, the synchronous communication device 101 is in a state of being communicable with all the synchronous communication devices 101 that perform synchronization processing. In order to construct a new wireless network for time synchronization in step S703 of S403, in the case of changing a network ID (hereinafter, BSSID), it is recommended to share a new BSSID and a password for connection before the end of step S401. Sharing the BSSID allows the BSSID to be made stealth in reconstructing a wireless network. This is expected to have an effect of deterring devices that require high traffic, which may affect synchronization accuracy, from participating in the wireless network.

In the description of the first exemplary embodiment, wireless time synchronization processing using IEEE802.11v has been taken as an example. However, it is not necessarily required to support IEEE802.11v in achieving time synchronization. What is necessary in achieving time synchronization is that the time synchronization destination correctly acquires the time of the time synchronization source. For that purpose, if there is a method for appropriately estimating a transmission delay in the wireless section, the value of the transmission delay is applied in advance, and the times notified to the time synchronization source and the transmission delay times are taken into account.

If the time synchronization source can notify the time while reserving a wireless band, it is possible to reduce the influence of transmission delays in the wireless section, and obtain favorable synchronization accuracy even if the devices do not necessarily support IEEE802.11v.

According to the present disclosure, it is possible to easily achieve time synchronization of synchronous communication devices connected to a wireless network.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-216832, filed Dec. 22, 2023, which is hereby incorporated by reference herein in its entirety.

What is claimed is:

1. A synchronous communication device comprising:
a first determination unit configured to determine whether its own synchronous communication device is to be a synchronization source or a synchronization destination when there is a request for time synchronization between the own synchronous communication device and another synchronous communication device that are connected to a wireless network; and
a second determination unit configured to determine whether a wireless mode of the own synchronous communication device is to be a master mode or a slave mode in accordance with the determination by the first determination unit.

2. The synchronous communication device according to claim 1, further comprising a synchronization processing unit configured to perform synchronization processing as the synchronization source when it is determined that the own synchronous communication device is to be the synchronization source, and perform synchronization processing as the synchronization destination when it is determined that the own synchronous communication device is to be the synchronization destination.

3. The synchronous communication device according to claim 1,
wherein, in a case where the own synchronous communication device does not have the master mode, the first determination unit determines that the own synchronous communication device is to be the synchronization destination,
wherein, in a case where the own synchronous communication device has the master mode and the other synchronous communication device does not have the master mode, the first determination unit determines that the own synchronous communication device is to be the synchronization source, and
wherein, in a case where the own synchronous communication device and the other synchronous communication device have the master mode, the first determination unit determines whether the own synchronous communication device is to be the synchronization source or the synchronization destination such that there is only one synchronization source.

4. The synchronous communication device according to claim 3, wherein, in a case where the own synchronous communication device and the other synchronous communication device have the master mode, the first determination unit determines, by Best Master Clock Algorithm (BMCA), whether the own synchronous communication device is to be the synchronization source or the synchronization destination.

5. The synchronous communication device according to claim 1, wherein the first determination unit determines whether the own synchronous communication device is to be the synchronization source or the synchronization destination based on information about the own synchronous communication device.

6. The synchronous communication device according to claim 1, wherein the first determination unit determines whether the own synchronous communication device is to be the synchronization source or the synchronization destination based on a remaining battery amount of the own synchronous communication device.

7. The synchronous communication device according to claim 1, wherein the first determination unit determines whether the own synchronous communication device is to be the synchronization source or the synchronization destination based on media access control (MAC) addresses of the own synchronous communication device and the other synchronous communication device.

8. The synchronous communication device according to claim 1, wherein, in a case where it is determined that the own synchronous communication device is to be the synchronization source, the second determination unit determines that the wireless mode of the own synchronous communication device is to be the master mode.

9. The synchronous communication device according to claim 1, wherein, in a case where it is determined that the own synchronous communication device is to be the synchronization destination, the second determination unit determines that the wireless mode of the own synchronous communication device is to be the slave mode.

10. The synchronous communication device according to claim 1, wherein, in a case where it is determined that the own synchronous communication device is to be the synchronization source and the wireless mode of the own synchronous communication device is the slave mode, the second determination unit changes the wireless mode of the own synchronous communication device to the master mode.

11. The synchronous communication device according to claim 1, wherein, in a case where it is determined that the own synchronous communication device is to be the synchronization destination and the wireless mode of the own synchronous communication device is the master mode, the second determination unit changes the wireless mode of the own synchronous communication device to the slave mode.

12. The synchronous communication device according to claim 1, further comprising a first display control unit configured to perform a control to display the number of synchronous communication devices in the slave mode connected to the wireless network before the determination by the first determination unit.

13. The synchronous communication device according to claim 2, further comprising a second display control unit configured to perform a control to display a message indicating that synchronization has been completed after the synchronous processing by the synchronous processing unit.

14. The synchronous communication device according to claim 2, wherein, in a case where it is determined that the own synchronous communication device is to be the synchronization destination, the synchronization processing unit corrects a time of the own synchronous communication device so as to synchronize with a time of the synchronous communication device that is the synchronization source.

15. A processing method of a synchronous communication device, comprising:
firstly determining whether its own synchronous communication device is to be a synchronization source or a synchronization destination when there is a request for time synchronization between the own synchronous communication device and another synchronous communication device that are connected to a wireless network; and
secondly determining whether a wireless mode of the own synchronous communication device is to be a master mode or a slave mode in accordance with the first determination.

16. A non-transitory computer-readable storage medium storing instructions that, when executed by a computer, cause the computer to perform a processing method of a synchronous communication device, the processing method comprising:
firstly determining whether its own synchronous communication device is to be a synchronization source or a synchronization destination when there is a request for time synchronization between the own synchronous communication device and another synchronous communication device that are connected to a wireless network; and
secondly determining whether a wireless mode of the own synchronous communication device is to be a master mode or a slave mode in accordance with the first determination.
